(19) United States
(12) Patent Application Publication
(10) Pub. No.: US 2025/0094549 A1
(43) Pub. Date: Mar. 20, 2025

(54) COMPLIANT AND AUDITABLE WAY FOR A USER TO PERFORM AN ACTION WITHOUT SUFFICIENT PRIVILEGES

(71) Applicant: Microsoft Technology Licensing, LLC, Redmond, WA (US)

(72) Inventors: Ram Kumar Donthula, Bothell, WA (US); Anand Rengasamy, Bothell, WA (US); Amber Bhargava, Issaquah, WA (US); Braden Wade Watkins, Eagle Mountain, UT (US); Muaz Ahmed Mian, Lynnwood, WA (US); Umang Anandkumar Shah, Bothell, WA (US); Jordan Alexander Mryyan, Overland Park, KS (US); Yulan He, San Jose, CA (US); Seunghwa Cha, Bellevue, WA (US); Dhara Kishorkumar Patel, Bellevue, WA (US)

(21) Appl. No.: 18/470,812

(22) Filed: Sep. 20, 2023

(51) Int. Cl. G06F 21/31

(52) U.S. Cl. CPC G06F 21/31

(57) ABSTRACT

Example aspects include techniques for providing a compliant and auditable approach for a user to perform an action without sufficient privileges. These techniques may include receiving, from a first user account, a first request to perform an action and determining that the first user account does not have permission to perform the action. In addition, the techniques may include identifying a second user account having permission to perform the action and transmitting, to the second user account, a second request for approval to perform the action. Further, the techniques may include performing in response to approval of the second request, the action without providing the permission to the first user account.

### BACKGROUND

In a cloud environment, resources and services like computing power, data storage, and software applications are provided over the internet, rather than being hosted on local servers or data centers. Cloud environments provide users with on-demand access to resources, resulting in high flexibility, scalability, and cost-effectiveness. Organizations can quickly add or remove resources like virtual machines, databases, and storage as needed, and easily manage expenses through usage-based pricing models. Additionally, cloud services often operate on a subscription basis, allowing businesses to access various software applications and tools without large upfront investments, which helps them stay current with technology and streamline operations.

In order to control costs, prevent unauthorized spending, and protect proprietary billing information, administrators often impose strict restrictions on adding resources/services and/or viewing billing information. As a result, users may face challenges such as limited resource access and difficulty obtaining authorization, which can cause inefficiencies and disruptions during task completion. For instance, access restrictions may cause delays in project completion as personnel struggle to obtain the necessary resources for their tasks. Additionally, personnel may not know whom to contact for permission to access specific resources, thereby wasting time and effort identifying responsible parties, and hindering productivity. These challenges can cause significant disruptions to workflows, preventing organizations from fully leveraging the benefits of cloud computing, and potentially leading to missed opportunities or increased costs.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In an aspect, a method includes receiving, from a first user account, a first request to perform an action, determining that the first user account does not have permission to perform the action, and identifying a second user account having permission to perform the action. The method may further include transmitting, to the second user account, a second request for approval to perform the action; and performing in response to approval of the second request, the action without providing the permission to the first user account.

In another aspect, a device may include one or more memories storing instructions, and one or more processors coupled to the memory and to execute the instructions to: receive, from a first user account, a first request to perform an action, determine that the first user account does not have permission to perform the action; identify a second user account having permission to perform the action; transmit, to the second user account, a second request for approval to perform the action; and perform in response to approval of the second request, the action without providing the permission to the first user account.

In another aspect, an example non-transitory computer-readable medium storing instructions for performing the methods described herein and an example apparatus including means of performing operations of the methods described herein are also disclosed.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example of a cloud computing system, in accordance with some aspects of the present disclosure

FIG. 2 illustrates an example graphical representation of a billing data structure, in accordance with some aspects of the present disclosure.

FIG. 3 is a flow diagram illustrating an example method for providing a compliant and auditable approach for a user to perform an action without sufficient privileges, in accordance with some aspects of the present disclosure.

FIG. 4 is a block diagram illustrating an example of a hardware implementation for a cloud computing device(s), in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes techniques for providing a compliant and auditable approach for a user to perform an action without sufficient privileges. In many systems, users are unable to execute actions without possessing the necessary permissions. Consequently, users must locate another individual who holds the appropriate permissions to complete the task. This process can be both challenging and disruptive to the task completion. Furthermore, when users are granted the required permissions, they often receive more privileges than necessary. For instance, a user might request access to specific information within a file, but receive a permission that grants access to the entire file instead. On the other hand, systems that permit actions to be performed on behalf of a user when the user does not possess the necessary permission may fail to adequately log performance of these actions to identify the user, thereby impeding the ability to audit log information. Such shortcomings present security risks and can lead to non-compliance with internal policies and/or government regulations.

In accordance with some aspects of the present disclosure, a cloud security module is configured to securely permit a user to cause performance of an action without sufficient privileges to perform the action. For example, the cloud security module may be configured to receive a requested action from a requesting user, identify another user with permission to perform the action, and request approval from the other user for the performance of the action for the requesting user. Further, the cloud security module may perform the action for the requesting user without elevating the privileges of the requesting user in response to the other user's approval of the action, and log the performance of the action by the other user on behalf of the requesting user. By identifying the other user to approve of performance, performing the action using the permission of the other user, and logging performance of the action by the other user on behalf of the requesting user, the cloud security module provides an efficient and secure access control policy for execution of processes within a cloud environment.

### Illustrative Environment

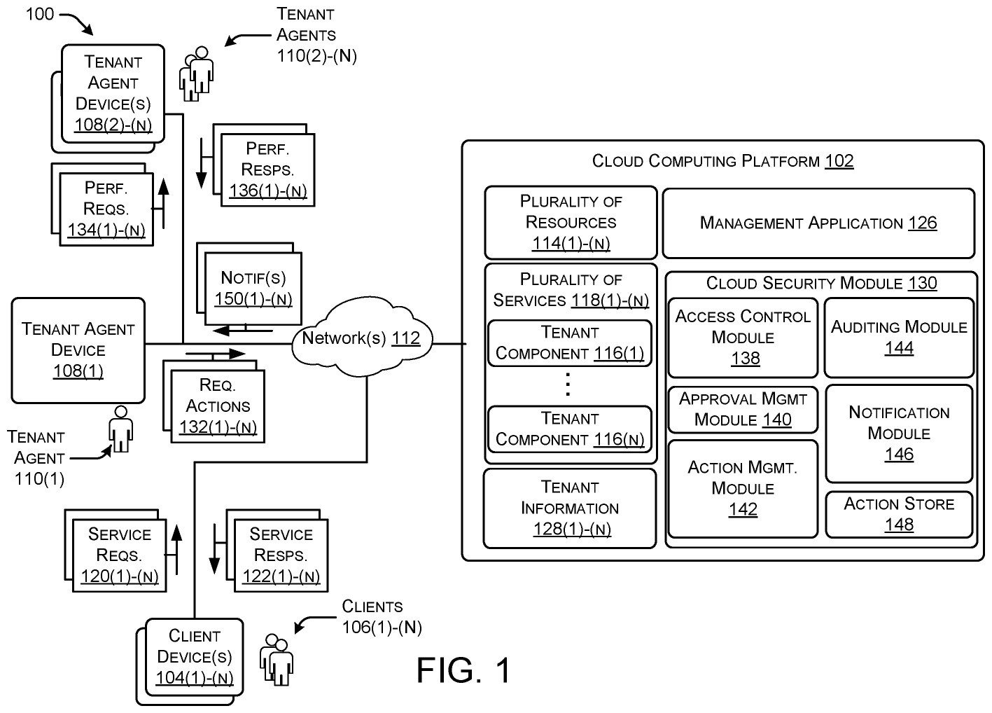

FIG. 1 is a diagram showing an example of a cloud computing system 100, in accordance with some aspects of the present disclosure. As illustrated in FIG. 1, the cloud computing system 100 may include a cloud computing platform 102, a plurality of client devices 104(1)-(n) associated with a plurality of clients 106(1)-(n), and a plurality of tenant agent devices 108(1)-(n) associated with a plurality of tenant agents 110(1)-(n). The cloud computing platform 102 may be a multi-tenant environment that provides the client devices 104(1)-(n) with access to applications, services, files, and/or data via one or more network(s) 112. In particular, the cloud computing platform 102 may implement a multi-tenant architecture wherein the resources 114(1)-(n) of the cloud computing platform 102 are shared among the tenants but individual data associated with each tenant is logically separated. As described herein, the tenants may be customers of the cloud computing platform 102. Additionally, a tenant agent 110 is an agent of a tenant of the cloud computing platform 102, and the tenant agent 110(1) has an account at the cloud computing platform 102. For example, a first tenant agent 108(1) is an engineer employed by a first tenant and the second tenant agent 108(2) is a billing coordinator employed by the first tenant. Further, the tenants may have relationships with the plurality of clients 106(1)-(n), and provide one or more tenant components 116(1)-(n) to the plurality of client devices 104(1)-(N) via the cloud computing platform 102.

As an example, the tenant component 116(1) may be a website, and the client device 104(1) may provide a client 106 access to the website. Further, the first tenant associated with the tenant component 116(1) may employ the cloud computing platform 102 to provide features of the website (i.e., tenant component 116(1)) to the client device 104(1). For instance, the tenant component 116(1) may configure the cloud computing platform 102 to transmit the content of the website to the client device 104(1) via the network 112. As another example, the tenant component 116(1) may be a database instance and the client device 104(1) may include a tenant application that utilizes the database instance via the network 112.

The network(s) 112 may comprise any one or combination of multiple different types of networks, such as cellular networks, wireless networks, local area networks (LANs), wide area networks (WANs), personal area networks (PANs), the Internet, or any other type of network configured to communicate information between computing devices (e.g., the cloud computing platform 102, the client devices 104(1)-(N), the tenant agent devices 108(1)-(n)). Some examples of the client devices 104(1)-(n) and the tenant agent devices 108(1)-(n) include computing devices, smartphone devices, Internet of Things (IoT) devices, drones, robots, process automation equipment, sensors, control devices, vehicles, transportation equipment, tactile interaction equipment, virtual and augmented reality (VR and AR) devices, industrial machines, virtual machines, etc.

Further, each tenant component 116 may be provided using one or more services 118 of the cloud computing platform 102. Some examples of the services 118(1)-(N) include infrastructure as a service (IaaS), platform as a service (PaaS), software as a service (SaaS), database as a service (DaaS), security as a service (SECaaS, big data as a service (BDaaS), a monitoring as a service (MaaS), logging as a service (LaaS), internet of things as a service (IOTaaS), identity as a service (IDaaS), analytics as a service (AaaS), function as a service (FaaS), and/or coding as a service (CaaS). Further, the resources 114(1)-(n) may be reserved for use by the services 118(1)-(n). Some examples of the resources 114(1)-(n) include computing units, bandwidth, data storage, application gateways, software load balancers, memory, field programmable gate arrays (FPGAs), graphics processing units (GPUs), input-output (I/O) throughput, data/instruction cache, physical machines, virtual machines, clusters of virtual machines, clusters of physical machines, etc. Further, the client devices 104(1)-(n) may transmit service requests 120(1)-(n) and receive service responses 122(1)-(n) corresponding to the service requests 120(1)-(n) in order to access the tenant components 116(1)-(n).

As illustrated in FIG. 1, the cloud computing system 100 may also include a management application 126 and tenant information 128(1)-(n). The management application 126 provides a web-based interface and/or an application programming interface (API) that allows tenant agents 110(1)-(n) to interact with and manage the plurality of resources 114(1)-(n) and the services 118(1)-(n). For example, in some aspects, the tenant agents 110(1)-(n) employ the management application 126 to create, configure, and manage the services 118(1)-(n), monitor and troubleshoot the performance and health of the resources 114(1)-(n), and configure access control and security settings to the plurality of resources 114(1)-(n) and the services 118(1)-(n) used by the tenant components 116(1)-(n). Further, in some aspects, the management application 126 enables the tenant agents 110(1)-(n) to manage billing and costs.

In order to maintain and/or improve the tenant components 116(1)-(n), the tenant agents 110(1)-(n) may endeavor to perform different actions at the cloud computing platform 102. For example, a tenant agent 110(1) may endeavor to subscribe to a service 118 and/or deploy additional resources 114 to an existing service 118 to add functionality to a tenant component 116. As another example, a tenant agent 110(1) may endeavor to view billing costs (e.g., a subscription costs) for one or more aspects of a tenant component 116 while gathering financial data when completing a project management task. However, often the tenant agents 110 that service the tenant components 116 are not provided the required permissions to perform desired actions at the cloud computing platform 102. For example, tenant agents 110 with billing responsibilities may prevent tenant agents 110 with service responsibilities from unilaterally subscribing to a service 118 and/or deploying additional resources 114 in order to control project costs and prevent unauthorized spending. As another example, tenant agents 110 with billing responsibilities may restrict access (e.g., viewing access) by the tenant agents 110 with service responsibilities to particular account information due to the inability to provide access to the tenant information with a preferred granularity.

As illustrated in FIG. 1, the cloud computing system 100 includes a cloud security module 130. As described in detail herein, in some aspects, the cloud security module 130 ensures that tenant agents 110 to perform requested actions in an auditable and secure fashion despite lacking the required privileges to perform the requested actions. In particular, the cloud security module 130 determines that a tenant agent 110(1) does not possess the required permission to perform a requested action 132, identifies another tenant agent 110(2) having the required permission, and transmits a performance request 134 to a tenant agent device 108(2) associated with the tenant agent 110(2). Some examples of a requested action 132 include viewing billing information, viewing subscription information, viewing client activity information, view log/audit information, subscribe to a service 118, modify usage of one or more resources 114.

In some aspects, the performance request 134 identifies the requesting tenant agent 110(1), the requested action 132, and one or more objects (e.g., files, services, users, accounts, devices, tenant components 116) associated with the requested action 132. Additionally, the cloud security module 130 receives a performance response 136 indicating whether the identified tenant agent 110(2) approves or denies the corresponding requested action 132. If the performance response 136 indicates that the identified tenant agent 110(2) approves of the performance of the requested action 132, the cloud security module 130 performs the requested action 132 as the identified tenant agent 110(2) without elevating the permissions of the requesting tenant agent 110(1). For example, the cloud security module 130 may cause the management application 126 to display financial information, subscribe to a service 118, and/or deploy a resource 114. Further, the cloud security module 130 logs the performance of the requested action 132 such that the activity log indicates that the requested action 132 was performed by the identified tenant agent 110(2) on behalf of the requesting tenant agent 110(1).

As illustrated in FIG. 1, the cloud security module 130 includes an access control module 138, an approval management module 140, an action management module 142, an auditing module 144, a notification module 146, and an action store 148. In some aspects, the access control module 138 manages various tasks to ensure security, privacy, and proper resource allocation among different tenant components 116. The access control module 138 handles authentication by verifying user identities before granting access to cloud resources. Additionally, the access control module 138 manages authorization by defining and enforcing permissions, privileges, and access levels for different tenant agent devices 108, tenant agents 110, and tenant components 116, and assigning roles based on the responsibilities of the tenant agent devices 108, the tenant agents 110, and the tenant components 116. For example, in some aspects, the access control module 138 determines that the requesting tenant agent 110(1) does not have permission to perform the requested action 132. Further, the access control module 138 ensures isolation of the different tenant components 116 to maintain privacy and security. In some aspects, the access control module 138 isolates the tenant components 116(1)-(n) through techniques such as network segmentation, encryption, and containerization.

The approval management module 140 identifies one or more tenant agents 110 that have permission to perform a requested action 132 in response to the access control module 138 denying a requested action 132 or otherwise determining that a requesting tenant agent 110 does not have permission to perform the requested action. Further, the approval management module 140 provides identifiers of the identified tenant agents 110(2) to the notification module 146. In some aspects, the approval management module 140 identifies one or more tenants having permission to perform the requested action 132 by determining the one or more tenants that are owners and/or contributors to a resource 114 and/or the tenant information 128 that is an object of the requested action 132, while not identifying one or more tenant agents 110 that are readers of a resource 114 and/or tenant information 128 that is an object of the requested action 132. In some aspects, an owner is a user having management, access control, and view permissions and a contributor is a user having management and view permissions without access control permissions. Further, in some aspects, the approval management module 140 employs the tenant information 128 (e.g., account ownership information) and/or an access control structure (e.g., an access control matrix, access control list, capability list, role-permission table, attribute policy database, hierarchical access control structure, etc.) to determine the tenant agents 110 having permission to perform the requested action 132.

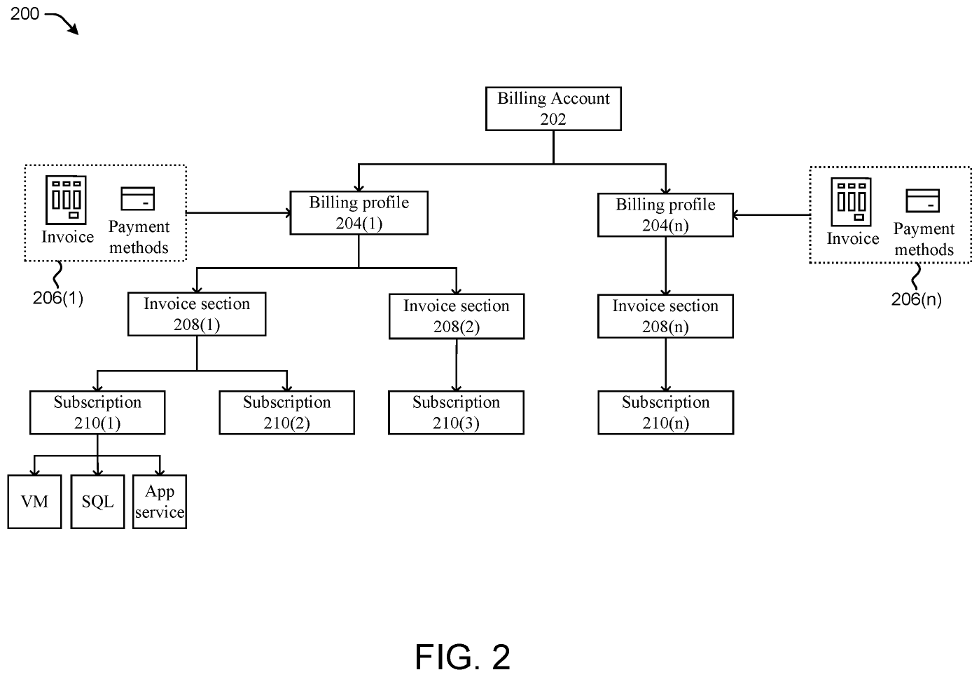

In some aspects, the cloud security module 130 stores permission information within a hierarchical data structure including a plurality of nodes. For example, as described in detail with respect to FIG. 2 below, in some aspects, the cloud security module 130 generates a data structure (e.g., a tree) including a plurality of hierarchical nodes representing billing and permission information. Additionally, in some aspects, the approval management module 140 identifies the tenant agents 110 having permission to perform a requested action 132 by traversing the tree. For example, if the owners and contributors associated with particular node within the tree do not respond to a performance request 134, the approval management module 140 identifies a one or more backup tenant agents 110 to contact for approval by traversing up the tree to a parent node and determining the owners and contributors corresponding to the parent node. Further, in some aspects, the approval management module 140 continues to traverse the ancestors of the particular node until a performance response 136 is received or a predefined number of traversal visits have been performed.

The action management module 142 manages the requested actions 132 through finality (e.g., performance of a requested action, expiration of a performance request 134, receipt of a performance request with a disapproval). For example, in response to the access control module 138 determining that the requesting tenant agent 110(1) does not have permission to perform the requested action 132, the action management module 142 stores the requested action within the action store 148. Additionally, in some aspects, the action management module 142 determines temporal constraints on the requested action 132 if performed by one of the identified tenant agents 110(2) on behalf of a requesting tenant agent 110(1). Some examples of a temporal constraint include a temporal limit on viewing an item of an invoice or a temporal limit on the execution of an instance of a deployed resource 114.

In some aspects, the action management module 142 determines the temporal constraints based upon an attribute of an object of the requested action 132 (e.g., a risk level of a value or file that would like to be viewed via the requested action 132), an attribute of the requesting tenant 110(1) (e.g., a role of the requesting tenant, a relevance between a role of the requesting tenant and an object of the requested action 132), and/or historic user activity data. Additionally, in some aspects, when the action management module 142 determines a temporal constraint on performance of the requested action 132, the action management module 142 stores the requested action 132 with the temporal constraint within the action store 148. For example, in some aspects, the action management module modifies the requested action 132 to impose the temporal constraint so that when the requested action 132 is retrieved from the action store 148 for performance, the requested action 132 is performed under the temporal constraint. Further, in some aspects, the action management module 142 employs machine learning techniques, pattern recognition techniques, and/or heuristic techniques to determine temporal constraints for the requested actions 132.

In addition, in some aspects, the action management module 142 determines an expiration date and time for performance of the requested action 132 via a performance request 134. In some aspects, the action management module 142 determines the expiration date and time based constraints based upon an attribute of an object of the requested action 132 (e.g., a risk level of a value or file that would like to be viewed via the requested action 132), an attribute of the requesting tenant (e.g., a role of the requesting tenant, a relevance between a role of the requesting tenant and an object of the requested action 132), and/or historic user activity data (e.g., average response time of the identified tenant agents 110, average response time for similar actions). Further, in some aspects, the action management module 142 employs machine learning techniques, pattern recognition techniques, and/or heuristic techniques to determine an expiration date and time for the requested actions 132.

In response to a performance response 136 including an approval from an identified tenant agent 110(2), the access control module 138 finds the corresponding requested action 132 and coordinates execution of the requested action 132 by the identified tenant agent 110(2) without elevating the privileges of the requested tenant agent 110 or providing greater access than initially requested by the requested action 132. Alternatively, in some aspects, in response to a performance response 136 including a disapproval, the access control module 138 deletes the corresponding requested action 132 or otherwise ensures that the requested action 132 is not subsequently performed.

In some aspects, the action management module 142 determines an alternate or supplemental action to present via a performance request 134 with a requested action 132. For example, in some aspects, the action management module 142 determines the alternate or supplemental action based on historic information identifying previously approved and disapproved requested actions 132 and other actions that were performed or requested thereafter. Further, in some aspects, the action management module 142 employs machine learning techniques, pattern recognition techniques, and/or heuristic techniques to determine the alternate or supplemental action. Additionally, or alternatively, in some aspects, the access control module 138 predicts whether the identified tenant agent 110(2) should approve or disapprove of a requested action 132 based on one or more attributes of the requested action 132, the requesting device 108(1), and/or the requesting tenant 110(1). Further, in some aspects, the action management module 142 determines to present an alternative or supplemental action based upon the access control module 138 predicting that a requested action 132 should not be approved.

The auditing module 144 monitors and audits activity and resource usage on the cloud computing platform 102. In some aspects, the auditing module 144 detects potential security breaches, unauthorized access, or misuse of resources. Further, in some aspects, the auditing module 144 maintains logs of user actions for auditing purposes and ensuring compliance with relevant regulations and policies. For example, in some aspects, when a requested action 132 of a requesting tenant agent 110(1) is performed in response to a performance response 136 indicating approval from an identified tenant agent 110(2), the auditing module 144 generates a log entry indicating that the requested action 132 was performed by the identified tenant agent 110 (2) on behalf of the requesting tenant agent 110(1).

The notification module 146 transmits the performance requests 134 to the identified tenant agents 110(2) and monitors for receipt of the performance responses 136 from the identified tenant agents 110(2). In some aspects, the notification module 146 sends the performance request 134 as an email to an identified tenant agent 110. Additionally, or alternatively, in some aspects, the notification module 146 sends the performance request 134 a message to an identified tenant agent 110(2) within the management application 126. Further, in some aspects, a performance request 134 includes a selectable control that launches a graphical user interface for providing approval or disapproval of the requested action 132. In addition, in some aspects, the graphical user interface also presents information about the requested action 132. For example, in some aspects, the graphical user interface presents an identification of the requesting tenant agent 110, the requested action 132, an object of the requested action 132, a prediction value indicating whether the identified tenant agent 110(2) should approve or disapprove the requested action 132, a temporal constraint on the requested action 132, and/or an expiration of the requested action 132. In some aspects, the GUI also permits an identified tenant agent 110(2) to modify the temporal constraint.

Further, the notification module 146 manages the lifecycle of the performance requests 134(1)-(n). For example, in some aspects, the notification module 146 re-transmits a performance request 134 as a reminder in response to determining that a corresponding performance response 136 has not been received for a previously-transmitted performance request 134. Additionally, in some aspects, the notification module 146 instructs the approval management module 140 to identify backup tenant agents 110(3) to contact for approval of a requested action 132 based upon passage of a predefined period time without receipt of a performance response 136 in response to previously-transmitted performance request 134, and transmits the performance request to the identified backup tenant agents 110(3).

Additionally, in some aspects, in response to receipt of a performance response 136 indicating approval of a requested action 132 and performance of the requested action 132, the notification module 146 transmits a notification 150 identifying the approval and performance of the requested action 132. Alternatively, in some aspects, in response to receipt of a performance response 136 indicating denial of a requested action 132 or expiration of the performance requests 134 corresponding to the requested action 132, the notification module 146 transmits a notification 150 identifying the denial of the requested action 132.

FIG. 2 illustrates an example graphical representation of a billing data structure 200, in accordance with some aspects of the present disclosure. In some aspects, billing data structure 200 is organized hierarchically into two or more main components, ie.g., billing account, billing profile, invoice section, and subscription. The four components and the relationships amongst the four components determine how resources are billed and managed within the agreement.

At the root node of the billing data structure 200, the billing account 202 represents a contractual agreement between an operator of a cloud computing platform and a tenant. The billing account 202 is responsible for managing billing-related activities for the tenant, such as tracking usage, managing billing profiles, and handling invoices. The owner of the billing account 202 has the highest level of permissions and can manage the billing components within the billing account. Further, in some aspects, each billing account 202 is associated with payment information 204. For example, an invoice may be generated at the billing account scope and settled using one or more payment methods linked to the billing account 202.

Within a billing account 202, there can be one or more billing profiles 206(1)-(n). The billing profiles 206(1)-(n) are created to separate and manage different types of costs and billing settings. In some aspects, each billing profile 206 has a corresponding payment method, invoice delivery preference, and/or tax information. Further, the owner of a billing profile 206 has the authority to manage the invoice sections 208 and subscriptions 210 within the billing profile 206

An invoice section 208 is a sub-component of a billing profile 206 and is used to group and organize subscriptions 210. Each invoice section 208 can have one or more subscriptions 210 assigned to the invoice section 208, and an invoice section 208 may help a tenant manage and track subscription costs more effectively. In some aspects, the owner of an invoice section 208 manages the subscriptions 210 within the invoice section 208 and views the corresponding charges on the invoice of the billing account 202.

Lastly, at the bottom of the billing data structure 200, a subscription 210 is used to manage and organize resources (e.g., the resources 114) and services (e.g., the services 118) (e.g., a virtual machine (VM) service, a structured query language (SQL) service, an app service). Subscriptions 210 are associated with an invoice section 208, and the costs the resources and the services used within a subscription 210 are billed according to the settings of the billing profile 206. In some aspects, an owner of a subscription 210 can manage the resources and services within their subscription 210, as well as view the usage and costs related to those resources and services.

Each level in the billing data structure 200 has a corresponding set of permissions and responsibilities, allowing for organized management of billing and resource/service usage within a cloud computing platform. Further, as described with respect to FIG. 1, in some aspects, an approval management module (e.g., the approval management module 140) identifies tenant agents (e.g., the tenant agents 110) having permission to perform a requested action (e.g., the requested action 132) based on the billing data structure 200. For example, a tenant agent may endeavor to view costs of a subscription 210(1) but lack the privileges to do so. In response, the approval management module identifies a tenant agent having permission to view costs of the subscription 210(1) based on identifying a viewer and/or an owner of the subscription 210(1). Additionally, in some aspects, the approval management module identifies another tenant to contact for approval by traversing up the billing data structure 200 to the invoice section 208(1) (i.e., the parent node of the subscription 210(1)) including the subscription 210(1) and identifying a viewer or owner of the invoice section 208(1).

### Example Process

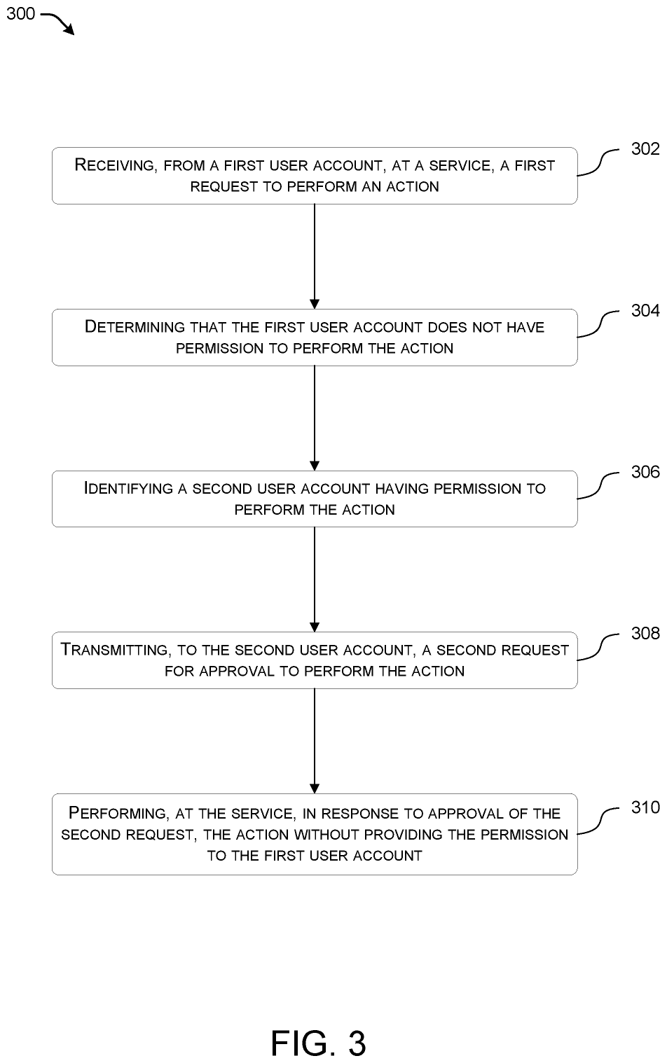

The processes described in FIG. 3 below are illustrated as a collection of blocks in a logical flow graph, which represent a sequence of operations that can be implemented in hardware, software, or a combination thereof. In the context of software, the blocks represent computer-executable instructions stored on one or more computer-readable media that, when executed by one or more processors, perform the recited operations. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. The operations described herein may, but need not, be implemented using the cloud computing platform 102. By way of example and not limitation, the method 300 is described in the context of FIGS. 1-2 and 4. For example, the operations may be performed by one or more of the management application 126, the cloud security module 130, the access control module 138, the approval management module 140, the action management module 142, the auditing module 144, and the notification module 146.

FIG. 3 is a flow diagram illustrating an example method 300 for providing a compliant and auditable approach for a user to perform an action without sufficient privileges, in accordance with some aspects of the present disclosure.

At block 302, the method 300 includes receiving, from a first user account, a first request to perform an action. For example, the cloud computing platform 102 receives a requested action 132(1) from a tenant agent device 108(1) employed by a requesting tenant agent 110(1). As described in detail herein, in some aspects, the requested action 132(1) corresponds to proposed activity over the plurality of resources 114(1)-(n), the plurality of tenant components 116(1)-(n), and/or the plurality of services 118(1)-(n). For instance, the requested action 132(1) may include at least one of creating new subscriptions to a service 118, deploying additional resources 114 to a tenant component 116, viewing the costs of an existing subscription to a service 118 or an existing deployment of resources 114 to a tenant component 116, and viewing the costs of a proposed subscription to a service 118 or a proposed deployment of resources 114 to a tenant component 116. Accordingly, the cloud computing platform 102, the computing device 400, and/or the processor 402 executing the management application 126 may provide means for receiving the first request from a first tenant agent 110(1) at a service to perform an action.

At block 304, the method 300 includes determining that the first user account does not have permission to perform the action. For example, the cloud computing platform 102 determines that the requesting tenant agent 110(1) does not have permission to perform the requested action 132(1). For instance, the requesting tenant agent 110(1) may be a service technician and the requested action 132(1) may be restricted to billing personnel within a tenant organization. Accordingly, the cloud computing platform 102, the computing device 400, and/or the processor 402 executing the access control module 138 may provide means for determining that the first user account does not have permission to perform the action.

At block 306, the method 300 includes identifying a second user account having permission to perform the action. For example, the cloud computing platform 102 determines that the tenant agents 110(2)-(3) are billing personnel having permission to perform the requested action 132(1). Accordingly, the cloud computing platform 102, the computing device 400, and/or the processor 402 executing the approval management module 140 may provide means for includes identifying a second user account having permission to perform the action.

At block 308, the method 300 includes transmitting, to the second user account, a second request for approval to perform the action. For example, the cloud computing platform 102 transmits the performance request 134(1) to the tenant agent device 108(2) associated with the tenant agent 110(2). In some aspects, the performance request 134(1) is an e-mail or a message on the management application 126 configured to receive or facilitate receipt of an approval or disapproval of performance of the requested action 132(1). Further, in some aspects, the performance request 134(1) causes the tenant agent 110(2) to be presented with a graphical user interface that displays the requested action 132(1), one or more objects of the requested action 132(1), an alternative requestion action 132(2), an expiration period for performance of the requested action 132(1), and/or an expiration period for the performance request 134(1). In addition, the graphical user interface may include an approval control (e.g., a button) that causes transmission of a performance response 136 indicating that the tenant agent 110(2) approves of performance of the requested action 132(1) when selected, and a disapproval control (e.g., a button) that causes transmission of a performance response 136 indicating that the tenant agent 110(2) disapproves of performance of the requested action 132(1) when selected.

Accordingly, the cloud computing platform 102, the computing device 400, and/or the processor 402 executing the notification module 146 may provide means for transmitting, to the second user account, a second request for approval to perform the action.

At block 310, the method 300 includes performing in response to approval of the second request, the action without providing the permission to the first user account. For example, in response to receipt of a performance response 136(1) indicating that the tenant agent 110(2) approves of performance of the requested action 132(1), the cloud computing platform 102 performs the requested action 132(1). In particular, the cloud computing platform 102 performs the requested action 132 as the tenant agent 110(2), and thereby does not have to provide additional permissions to tenant agent 110(1).

Accordingly, the cloud computing platform 102, the computing device 400, and/or the processor 402 executing the action management module 142 may provide means for performing in response to approval of the second request, the action without providing the permission to the first user account.

Additionally, or alternatively, in an aspect, the method 300 may further include wherein the permission permits the action over a plurality of resources, and performing the action includes performing the action over a resource of the plurality of resources and not over other resources of the plurality of resources. For example, in some aspects, the requested action 132 may be to view a line item of an invoice and the cloud security module 130 displays the line item of the invoice without displaying the remaining information of the invoice. Accordingly, the cloud computing platform 102, the cloud computing device 400, and/or the processor 402 executing the access control module 138, the action management module 142, the management application 126, and/or the service 118 may provide means for performing the action includes performing the action over a resource of the plurality of resources and not over other resources of the plurality of resources.

Additionally, or alternatively, in an aspect, the method 300 may further include logging performance of the action by the second user account in response to the request from the first user account. For example, the cloud computing platform 102 logs performance of the requested action 132(1) as being performed by the tenant agent 110(2) on behalf of the tenant agent 110(1). Accordingly, the cloud computing platform 102, the cloud computing device 400, and/or the processor 402 executing the auditing module 144 may provide means for logging performance of the action by the second user account in response to the request from the first user account.

Additionally, or alternatively, in an aspect, the method 300 may further include notifying the first user account of performance of the action. For example, the cloud computing platform 102 transmits a notification 150 to the tenant agent device 108(1) indicating that the requested action 132(1) has been performed. Accordingly, the cloud computing platform 102, the cloud computing device 400, and/or the processor 402 executing the notification module 146 may provide means for notifying the first user account of performance of the action.

Additionally, or alternatively, in an aspect, the method 300 may further include wherein the permission provides access to a resource for a first predetermined period of time, and wherein performing the action includes providing access to the resource for a second predetermined period of time that is less than the first predetermined period of time. For example, the cloud computing platform 102 determines an expiration period for the requested action 132(1) and modifies the requested action 132(1) to reflect the expiration period. Further, in response to a performance response 136, the cloud computing platform 102 performs the requested action 132(1) in view of the expiration period. Accordingly, the cloud computing platform 102, the cloud computing device 400, and/or the processor 402 executing action management module 142, a service 118, and/or the management application 126 may provide means providing access to the resource for a second predetermined period of time that is less than the first predetermined period of time

Additionally, or alternatively, in an aspect, the method 300 may further include wherein the action is a first action, and further include: receiving, from the first user account, at a second service, a third request to perform a second action; determining that the first user account does not have permission to perform the second action; identifying a third user account having permission to perform the second action; identifying, based on a resource associated with the second action, an alternative action to the second action; transmitting, to the third user account, a fourth request for approval to perform the second action or the alternative action to the second action; and performing, in response to approval of the fourth request, the second action or the alternative to the second action without providing the permission to the first user account. For example, in some aspects, in response to receipt of a second requested action 132(2) from the tenant agent device 108(1), the cloud security module 130 transmits a performance request 134(2) including the requested action 132(2) and an alternate action to the tenant agent device 108(2), and receives a performance response 136(2) indicating approval of performance of the alternate action from the tenant agent device 108(2). Further, the cloud security module 130 performs the alternate action based on receipt of the performance response 136(2).

Accordingly, the cloud computing platform 102, the cloud computing device 400, and/or the processor 402 executing the action management module 142, the approval management module 140, a service 118, the notification module 146 and/or the management application 126 may provide means receiving, from the first user account, at a second service, a third request to perform a second action; determining that the first user account does not have permission to perform the second action; identifying a third user account having permission to perform the second action; identifying, based on a resource associated with the second action, an alternative action to the second action; transmitting, to the third user account, a fourth request for approval to perform the second action or the alternative action to the second action; and performing, in response to approval of the fourth request, the second action or the alternative to the second action without providing the permission to the first user account

Additionally, or alternatively, in an aspect, the method 300 may further include wherein the action is a first action, and further include: receiving, from the first user account, at a second service, a third request to perform a second action; determining that the first user account does not have permission to perform the second action; identifying a third user account having permission to perform the second action; transmitting, to the third user account, a fourth request for approval to perform the second action; denying, based on the fourth request, performance of the second action; and notifying the first user account of denial of the third request. For example, in some aspects, in response to receipt of a second requested action 132(2) from the tenant agent device 108(1), the cloud security module 130 transmits a performance request 134(2) including the requested action 132(2) to the tenant agent device 108(2), and receives a performance response 136(2) indicating denial of performance of the requested action 132(2) from the tenant agent device 108(2). Further, the cloud security module 130 transmits a notification 150 of the denial to the tenant agent device 108(1). Accordingly, the cloud computing platform 102, the cloud computing device 400, and/or the processor 402 executing the action management module 142, the approval management module 140, a service 118, the notification module 146 and/or the management application 126 may provide means receiving, from the first user account, at a second service, a third request to perform a second action; determining that the first user account does not have permission to perform the second action; identifying a third user account having permission to perform the second action; transmitting, to the third user account, a fourth request for approval to perform the second action; denying, based on the fourth request, performance of the second action; and notifying the first user account of denial of the third request

Additionally, or alternatively, in an aspect, the method 300 may further include wherein identifying the second user account having permission to perform the action, includes: determining that the second user account is an owner or contributor to a resource that is an object of the action. For example, in some aspects, the cloud security module 130 determines the owner or contributor to a resource or a service associated with the requested action 132. In some instances, the owner or contributor is identified within the tenant information 128 and/or the billing data structure 200. Accordingly, the cloud computing platform 102, the cloud computing device 400, and/or the processor 402 executing the approval management module 140 may provide means determining that the second user account is an owner or contributor to a resource that is an object of the action

Additionally, or alternatively, in an aspect, the method 300 may further include wherein a third user account corresponds to an owner of a resource that is an object of the action, and identifying the second user account having permission to perform the action, includes: determining that the third user account has not responded to a third request to perform the action; and identifying the second user account based on the second user account being an administrator of a plurality of resources including the resource. For example, in some aspects, the cloud security module 130 determines that a tenant agent 110(3) has not responded to a performance request 134(2) within a predefined period of time. As a result, the cloud security module 130 identifies that the tenant agent 110(2) has administrator privileges over a plurality of resources 114 including a resource 114 associated with the requested action 132 using the billing data structure 200 and/or the tenant information 128, and transmits the performance request 134(1) to the tenant agent device 108(2) as a backup option. Accordingly, the cloud computing platform 102, the cloud computing device 400, and/or the processor 402 executing the approval management module 140 and the notification module 146 may provide means determining that the third user account has not responded to a third request to perform the action; and identifying the second user account based on the second user account being an administrator of a plurality of resources including the resource.

While the operations are described as being implemented by one or more computing devices, in other examples various systems of computing devices may be employed. For instance, a system of multiple devices may be used to perform any of the operations noted above in conjunction with each other.

### Illustrative Computing Device

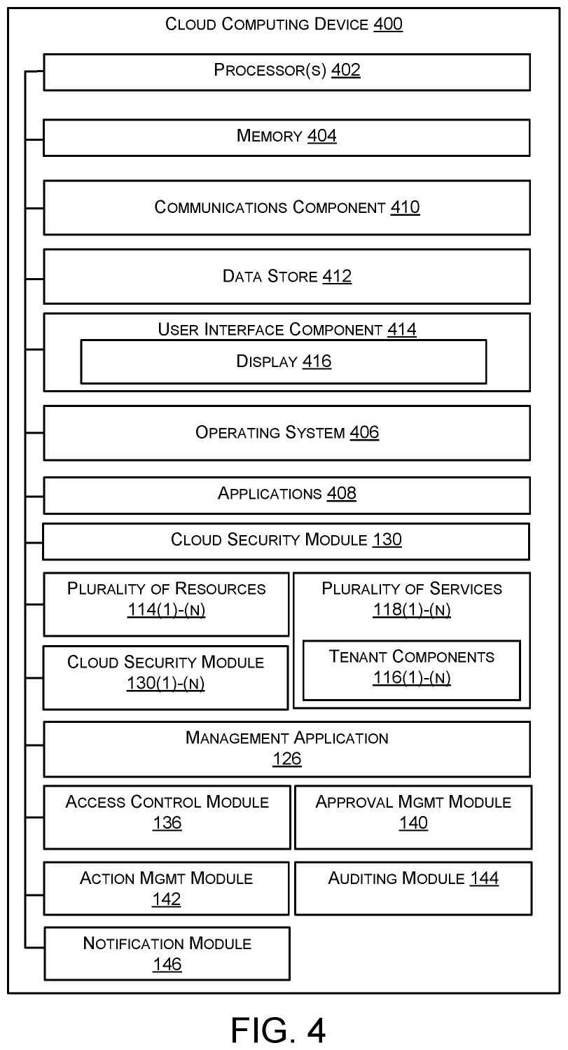

Referring now to FIG. 4, an example of a cloud computing device(s) 400 (e.g., cloud computing platform 102). In one example, the cloud computing device(s) 400 includes the processor 402 for carrying out processing functions associated with one or more of components and functions described herein. The processor 402 can include a single or multiple set of processors or multi-core processors. Moreover, the processor 402 may be implemented as an integrated processing system and/or a distributed processing system. In an example, the processor 402 includes, but is not limited to, any processor specially programmed as described herein, including a controller, microcontroller, a computer processing unit (CPU), a graphics processing unit (GPU), an application specific integrated circuit (ASIC), a field programmable gate array (FPGA), a system on chip (SoC), or other programmable logic or state machine. Further, the processor 402 may include other processing components such as one or more arithmetic logic units (ALUs), registers, or control units.

In an example, the cloud computing device 400 also includes the memory 404 for storing instructions executable by the processor 402 for carrying out the functions described herein. The memory 404 may be configured for storing data and/or computer-executable instructions defining and/or associated with the operating system 406, the plurality of services 118(1)-(n), the management application 126, the cloud security module 130, the access control module 138, the approval management module 140, the action management module 142, the auditing module 144, and the notification module 146, and the processor 402 may execute the operating system 406, the plurality of services 118(1)-(n), the management application 126, the cloud security module 130, the access control module 138, the approval management module 140, the action management module 142, the auditing module 144, and the notification module 146. An example of memory 404 may include, but is not limited to, a type of memory usable by a computer, such as random access memory (RAM), read only memory (ROM), tapes, magnetic discs, optical discs, volatile memory, non-volatile memory, and any combination thereof. In an example, the memory 404 may store local versions of applications being executed by processor 402.

The example cloud computing device 400 also includes a communications component 410 that provides for establishing and maintaining communications with one or more parties utilizing hardware, software, and services as described herein. The communications component 410 may carry communications between components on the cloud computing device 400, as well as between the cloud computing device 400 and external devices, such as devices located across a communications network and/or devices serially or locally connected to the cloud computing device 400. For example, the communications component 410 may include one or more buses, and may further include transmit chain components and receive chain components associated with a transmitter and receiver, respectively, operable for interfacing with external devices. In an implementation, for example, the communications component 410 may include a connection to communicatively couple the client devices 104(1)-(N) and the tenant devices 110(1)-(N) to the processor 402.

The example cloud computing device 400 also includes a data store 412, which may be any suitable combination of hardware and/or software, that provides for mass storage of information, databases, and programs employed in connection with implementations described herein. For example, the data store 412 may be a data repository for the operating system 406 and/or the applications 408.

The example cloud computing device 400 also includes a user interface component 414 operable to receive inputs from a user of the cloud computing device 400 and further operable to generate outputs for presentation to the user. The user interface component 414 may include one or more input devices, including but not limited to a keyboard, a number pad, a mouse, a touch-sensitive display (e.g., display 416), a digitizer, a navigation key, a function key, a microphone, a voice recognition component, any other mechanism capable of receiving an input from a user, or any combination thereof. Further, the user interface component 414 may include one or more output devices, including but not limited to a display (e.g., display 416), a speaker, a haptic feedback mechanism, a printer, any other mechanism capable of presenting an output to a user, or any combination thereof.

In an implementation, the user interface component 414 may transmit and/or receive messages corresponding to the operation of the operating system 406 and/or the applications 408. In addition, the processor 402 executes the operating system 406 and/or the applications 408, and the memory 404 or the data store 412 may store them.

Further, one or more of the subcomponents of the plurality of services 118(1)-(n), the management application 126, the cloud security module 130, the access control module 138, the approval management module 140, the action management module 142, the auditing module 144, and the notification module 146, may be implemented in one or more of the processor 402, the applications 408, the operating system 406, and/or the user interface component 414 such that the subcomponents of the plurality of services 118(1)-(n), the management application 126, the cloud security module 130, the access control module 138, the approval management module 140, the action management module 142, the auditing module 144, and the notification module 146, are spread out between the components/subcomponents of the cloud computing device 400.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various implementations or features may have been presented in terms of systems that may include a number of devices, components, modules, and the like. A person skilled in the art should understand and appreciate that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or procedure described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or procedure may reside as one or any combination or set of codes and/or instructions on a machine readable medium and/or computer readable medium, which may be incorporated into a computer program product.

In one or more implementations, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

### Conclusion

In closing, although the various embodiments have been described in language specific to structural features and/or methodological acts, it is to be understood that the subject matter defined in the appended representations is not necessary limited to the specific features or acts described. Rather, the specific features and acts are disclosed as example forms of implementing the claimed subject matter.

What is claimed is:

1. A method comprising:
receiving, from a first user account, a first request to perform an action;
determining that the first user account does not have permission to perform the action;
identifying a second user account having permission to perform the action;
transmitting, to the second user account, a second request for approval to perform the action; and
performing in response to approval of the second request, the action without providing the permission to the first user account.

2. The method of claim 1, wherein the permission permits the action over a plurality of resources, and performing the action comprises performing the action over a resource of the plurality of resources and not over other resources of the plurality of resources.

3. The method of claim 1, further comprising: logging performance of the action by the second user account in response to the request from the first user account.

4. The method of claim 1, further comprising: transmitting a notification to the first user account indicating performance of the action.

5. The method of claim 1, wherein the permission provides access to a resource for a first predetermined period of time, and wherein performing the action comprises providing access to the resource for a second predetermined period of time that is less than the first predetermined period of time.

6. The method of claim 1, wherein the action is a first action, and further comprising:
receiving, from the first user account, a third request to perform a second action;
determining that the first user account does not have permission to perform the second action;
identifying a third user account having permission to perform the second action;
identifying, based on a resource associated with the second action, an alternative action to the second action;
transmitting, to the third user account, a fourth request for approval to perform the second action or the alternative action to the second action; and
performing, in response to approval of the fourth request, the second action or the alternative to the second action without providing the permission to the first user account.

7. The method of claim 1, wherein the action is a first action, and further comprising:
receiving, from the first user account, at a second service, a third request to perform a second action;
determining that the first user account does not have permission to perform the second action;
identifying a third user account having permission to perform the second action;
transmitting, to the third user account, a fourth request for approval to perform the second action;
denying, based on the fourth request, performance of the second action; and
notifying the first user account of denial of the third request.

8. The method of claim 1, wherein identifying the second user account having permission to perform the action, comprises:
determining that the second user account is an owner or contributor to a resource that is an object of the action.

9. The method of claim 1, wherein a third user account corresponds to an owner of a resource that is an object of the action, and identifying the second user account having permission to perform the action, comprises:
determining that the third user account has not responded to a third request to perform the action; and
identifying the second user account based on the second user account being an administrator of a plurality of resources including the resource.

10. A cloud computing platform device, comprising:
one or more memories storing instructions; and
one or more processors communicatively coupled with the one or more memories and configured to:
receive, from a first user account, a first request to perform an action;
determine that the first user account does not have permission to perform the action;
identify a second user account having permission to perform the action;
transmit, to the second user account, a second request for approval to perform the action; and
perform in response to approval of the second request, the action without providing the permission to the first user account.

11. The cloud computing platform device of claim 10, wherein the permission permits the action over a plurality of resources, and to perform the action, the one or more processors are configured to:
performing the action over a resource of the plurality of resources and not over other resources of the plurality of resources.

12. The cloud computing platform device of claim 10, wherein the one or more processors are further configured to log performance of the action by the second user account in response to the request from the first user account.

13. The cloud computing platform device of claim 10, wherein the permission permits the action over a plurality of resources, and to perform the action, the one or more processors are configured to:
perform the action over a resource of the plurality of resources and not over other resources of the plurality of resources.

14. The cloud computing platform device of claim 10, wherein the action is a first action, and the one or more processors are further configured to:
receive, from the first user account, at a second service, a third request to perform a second action;
determine that the first user account does not have permission to perform the second action;
identify a third user account having permission to perform the second action;
transmit, to the third user account, a fourth request for approval to perform the second action;
deny, based on the fourth request, performance of the second action; and
notify the first user account of denial of the third request.

15. The cloud computing platform device of claim 10, wherein to identify the second user account, the one or more processors are configured to:
determine that the second user account is an owner or contributor to a resource that is an object of the action.

16. The cloud computing platform device of claim 10, wherein a third user account corresponds to an owner of a resource that is an object of the action, and to identify the second user account, the one or more processors are configured to:
determine that the third user account has not responded to a third request to perform the action; and
identify the second user account based on the second user account being an administrator of a plurality of resources including the resource.

17. A non-transitory computer-readable device storing instructions thereon that, when executed by at least one computing device, causes the at least one computing device to perform operations comprising:
receiving, from a first user account, a first request to perform an action;
determining that the first user account does not have permission to perform the action;
identifying a second user account having permission to perform the action;
transmitting, to the second user account, a second request for approval to perform the action; and
performing in response to approval of the second request, the action without providing the permission to the first user account.

18. The non-transitory computer-readable device of claim 17, wherein the permission permits the action over a plurality of resources, and performing the action comprises performing the action over a resource of the plurality of resources and not over other resources of the plurality of resources.

19. The non-transitory computer-readable device of claim 17, wherein the operations further comprise:
logging performance of the action by the second user account in response to the request from the first user account.

20. The non-transitory computer-readable device of claim 17, wherein the permission provides access to a resource for a first predetermined period of time, and wherein performing the action comprises providing access to the resource for a second predetermined period of time that is less than the first predetermined period of time.
